(19) United States
(12) Patent Application Publication
(10) Pub. No.: US 2021/0002072 A1
(43) Pub. Date: Jan. 7, 2021

(54) METHOD FOR OPERATING A CONTAINER, AND CONTAINER

(71) Applicant: ZENTIS GMBH & CO. KG, Aachen (DE)

(72) Inventors: Phillip KÖNIG, Aachen (DE); Tim FREIALDENHOVEN,, Eschweiler (DE); Ivo Frederik WASSERKORDT, Lanaken (BE); Peter STELTER, Aachen (DE); Stephan JANSEN, Aachen (DE)

(21) Appl. No.: 16/982,685

(22) PCT Filed: Mar. 5, 2019
(86) PCT No.: PCT/EP2019/055450

§ 371 Date: Sep. 21, 2020

(30) Foreign Application Priority Data
Mar. 22, 2018 (DE) 10 2018 106 786.0

(51) Int. Cl. B65D 90/48; G01F 22/02; G01F 23/18; B67D 3/00; B65D 81/18

(52) U.S. Cl. CPC B65D 90/48; G01F 22/02; B65D 2590/0083; B67D 3/0061; B65D 81/18; G01F 23/18

(57) ABSTRACT

A method for operating a container having a frame and a tank supported a distance from the ground by the frame so that a bottom side of the tank is accessible, includes connecting a protective gas line to a gas connection on the tank and applying pressure to the protective gas line before removing filling material from the tank so that protective gas can flow into the interior of the tank through a medium channel. A removal apparatus is connected to an opening of the tank and filling material present in the tank is removed from an interior of the tank through the opening. Data relating to a pressure of protective gas in the medium channel is detected by a pressure sensor at least during a time period of removing the filling material from the tank.

### INTRODUCTION

The present application relates to a method as claimed in the preamble of claim 1. The present application further relates to a container as claimed in the preamble of claim 10.

A container of the generic type can be used, in particular, to hold an aqueous, flowable filling material. In this respect, so-called fruit preparations which, for example, are filled at the manufacturer's premises and then sold to customers can be mentioned by way of example. The container comprises, in particular, a frame and a tank, wherein the tank can be supported at a distance above the ground by means of the frame. In this way, the tank is accessible from its bottom side. The tank has at least one opening on said bottom side, by means of which opening the tank can be charged with filling material or filling material can be removed from the tank. In order to prevent contamination of the filling material, in particular by oxygen, the tank additionally has at least one gas connection by means of which a protective gas line can be connected to the tank. It is possible to feed a protective gas, for example carbon dioxide, to the tank by means of a protective gas line of this kind. This ensures that, in addition to the filling material itself, an interior of the tank is filled exclusively with the protective gas. This results in the filling material which is located in the tank not being spoilt owing to contact with ambient air.

The connection of the protective gas line to the gas connection of the tank generally takes place before a removal apparatus is connected to the opening of the tank. As a result, at the time at which filling material is removed from the tank, the protective gas line is already connected in any case and protective gas can subsequently flow into the interior of the tank at any time. Accordingly, it is customary to detach the protective gas line from the tank only when removal of filling material has finished. In particular, it is conceivable to always first disconnect the removal apparatus from the opening before the protective gas line is detached from the gas connection.

The container is preferably formed from stainless steel, so that it can be used as frequently as desired, that is to say charged and discharged in particular. If the filling material has a comparatively high viscosity, it may be expedient to pump out the filling material by means of a pump in order to remove said filling material from the tank. In order to ensure adequate subsequent flow of protective gas during the course of removal of the filling material from the interior of the tank, it is additionally advantageous when the protective gas line is connected to a pressure source which provides the protective gas under a specific pressure. This ensures that no foreign gas, in particular no ambient air, accidentally flows into the tank.

### PRIOR ART

Containers of the kind described at the outset are already known in the prior art. In this respect, reference is made, by way of example, to European patent EP 1 544 030 B1, which concerns a frame of a container of this kind.

In everyday logistics relating to containers of this kind, it has been found that it is desirable to be able to track the filling level of a container of this kind. To this end, it is customary to place a respective container on a set of scales during the course of removal of filling material from its tank, by means of which a change in the mass of the container can be determined, from which a conclusion can, in turn, be drawn about the quantity of filling material removed. However, this procedure is disadvantageous insofar as a set of scales of this kind is required in every case in order to monitor the filling level of the container. It should be noted here that it is very common in practice for a respective container to be emptied in stages, where possible over a relatively long time period. In contrast, emptying “in one go” is comparatively unusual. Therefore, there is interest, in principle, in individually tracking the filling levels of individual containers, so that it is always clear what quantity of the filling material is still available.

### Problem

The present application is based on the problem of providing a method by means of which a filling level of a respective container can be determined more easily than in the prior art. In addition, a container which allows a filling level to be determined in a simple manner is also intended to be specified.

### Solution

According to the invention, the underlying problem is solved by means of a method having the features of claim 1. Advantageous refinements can be gathered from dependent claims 2 to 9. A container for solving the problem can be gathered from the features of claim 10. Advantageous refinements can be gathered from dependent claims 10 to 21.

The method makes provision for a protective gas line to be connected to the gas connection and pressure to be applied to said protective gas line before removal of filling material from the tank. A corresponding procedure has already been outlined in the introductory part. Furthermore, a removal apparatus is connected to the opening of the tank, so that filling material can be removed from the tank by means of the removal apparatus. In principle, the connection of the protective gas line and the connection of the removal apparatus to the container are not subject to any chronological sequence. The critical factor is merely that the protective gas line is connected to the tank and pressure is applied to said protective gas line before actual removal of the filling material, so that protective gas can be adjusted and can therefore fill a volume which is released in the tank on account of removal of the filling material.

According to the invention, data relating to a pressure of the protective gas in the medium channel is detected by means of at least one pressure sensor at least during a time period of removal of the filling material from the tank. The “medium channel” can relate, in principle, to any line through which the protective gas can flow into the tank. In particular, the medium channel can be formed directly on the protective gas line or on or in the container itself. However, as an alternative, it is likewise conceivable for the medium channel to be formed on an adapter element which is connected to the container in a force-transmitting manner. For example, it is conceivable to connect a corresponding adapter element to the gas connection of the tank, wherein the adapter element is equipped with the pressure sensor. In a situation of this kind, the protective gas line can be connected to the adapter element, so that the protective gas which is provided by means of the protective gas line can flow through the adapter element or a medium channel of said adapter element to the gas connection of the tank and finally into the interior of the tank.

It is merely necessary for the method according to the invention for the at least one medium channel, through which the protective gas flows into the tank, to be equipped with a pressure sensor, so that a pressure of the protective gas in the medium channel can be at least indirectly detected by means of the pressure sensor. In this case, the “pressure” does not necessarily have to denote a total pressure of the protective gas. Instead, it is likewise possible for the detected pressure to describe only a partial pressure of the protective gas, for example a dynamic pressure or a static pressure of the protective gas. The dynamic pressure of the protective gas is determined by the flow rate of said protective gas within the medium channel.

The static pressure within the medium channel can be detected, for example, by means of a spur line which extends in an inclined manner, preferably perpendicularly, to a longitudinal axis of the medium channel and is connected to a medium channel, wherein the pressure sensor is arranged at an end of the spur line that is averted from the medium channel. In an arrangement of this kind, a flow of the protective gas through the medium channel is oriented perpendicularly to the spur line, so that a pressure which is detected by means of the pressure sensor which is arranged at the end of the spur line is free of a proportion of the dynamic pressure in the total pressure of the protective gas. Instead, only the static pressure of the protective gas is detected by means of a pressure sensor of this kind.

As an alternative or in addition, it is likewise conceivable to equip the medium channel with a pitot tube which has a section which extends in the direction of the medium channel parallel to the longitudinal axis. By means of an opening cross section, a pitot tube of this kind is suitable for receiving protective gas flowing through the medium channel, wherein a total pressure of the protective gas, that is to say the sum of a static and a dynamic pressure of the protective gas, can be detected by means of a pressure sensor which is arranged at an end of the pitot tube that is averted from the medium channel. By means of combined detection of the total pressure and of the static pressure, conclusions can be drawn about the dynamic pressure of the protective gas by means of subtraction. Combined detection of total pressure and static pressure is possible, for example, by means of a Prandtl tube, the use of which is equally conceivable here. Alternative arrangements of a pressure sensor on or in a medium channel are of course likewise conceivable.

According to the invention, it is possible to establish times at which removal of filling material from the tank begins and ends by means of determining a pressure of the protective gas in the medium channel. The difference between these times gives a time period within which removal of filling material from the tank has taken place. The extent of this time period in turn allows a conclusion to be drawn about how much filling material has been removed from the tank. In this way, it is possible to track, starting from a completely filled tank, the remaining filling level of the tank after removal of filling material, wherein the use of a set of scales known from the prior art can be omitted. If it is established, for example, by means of evaluation of a pressure profile of the protective gas that filling material was removed from the tank over a time period of 10 minutes, it is possible to determine precisely, when the mass flow of removal of the filling material from the tank is known, the remaining filling level of said filling material in relation to the starting filling level at the beginning of removal.

The method according to the invention has many advantages. In particular, it is possible to monitor a large number of containers in a decentralized manner and without further external auxiliary means and to individually track the filling level of each individual container. To this end, it is merely necessary to arrange at least one pressure sensor in or on a medium channel of the container and to process data which is detected by means of the pressure sensor. A respective container can be equipped with a pressure sensor of this kind in a particularly simple manner by means of an adapter element which can be inserted into the gas connection, as will be outlined separately below.

In a development of the method according to the invention, a statement can additionally be made, depending on the pressure conditions, about the magnitude of the volume flow of the protective gas subsequently flowing into the tank and accordingly also the mass flow of the filling material which is removed from the tank. In this way, the “removal rate” relating to the filling material can be taken into account as an additional parameter. The volume flow of the subsequently flowing protective gas is proportional to the mass flow of the filling material which is removed from the tank, so that the filling level of the tank can be quantitatively precisely determined. If, however, the mass flow of the removed filling material cannot be determined, the filling level can be sufficiently precisely estimated for a specific filling material on the basis of the determined removal time assuming typical values for the mass flow during removal. In each case, first removal of filling material from the completely filled tank and complete emptying of the tank can be established at least reliably by way of evaluating the pressure curve. Qualitative filling level control is therefore always possible with the pressure sensor.

In an advantageous refinement of the method according to the invention, the protective gas in the medium channel is accelerated, in particular by means of a constriction which is arranged in the medium channel. A constriction of this kind is determined in that a cross section of the medium channel in the region of the constriction is smaller than a cross section of the medium channel outside the constriction. The acceleration of the protective gas in the region of the constriction leads to a dynamic pressure of the protective gas locally increasing, whereas the static pressure correspondingly decreases. This concerns cases at least of the kind in which a total pressure of the protective gas that is provided by a pressure source is at least substantially, in particular completely, constant. The acceleration of the protective gas within the medium channel in regions makes it easier, in particular, to establish changes in a volume flow which flow through the medium channel into the interior of the tank.

Gathering data relating to a change of this kind is advantageous insofar as data of this kind can be used to indirectly determine the mass flow with which filling material is removed from the tank. This is based on the consideration that the faster filling material is removed from the tank, the more quickly protective gas subsequently flows through the medium channel. Gathering information about the pressure conditions in the medium channel, for example in accordance with the Venturi principle or by means of a pitot tube, can accordingly be useful for making a corresponding statement. The detected static and dynamic pressure allows the flow rate of the protective gas in a flow cross section to be calculated using Bernoulli's law. Calculation of the mass flow of the inflowing protective gas is then the result of the product of the density of the protective gas, the calculated flow rate and the flow cross section. As an alternative or in addition, it is conceivable to directly and separately determine a mass flow of the filling material emerging from the tank through the opening, wherein the arrangement of a corresponding flow sensor at the opening of the tank is possible for example.

In a further advantageous refinement of the method according to the invention, data which is detected by means of the pressure sensor is at least temporarily stored by means of a data logger. In particular, it is conceivable to store the detected data at least until the tank is completely emptied. Furthermore, it may be advantageous when the data which is detected by means of the pressure sensor is processed by means of an evaluation unit. The latter can determine changes in the pressure which is present in the medium channel, for example, by means of a stored algorithm and on the basis of said changes determine times at which removal of filling material from the tank begins and/or ends.

In order to be able to externally evaluate detected data or to be able to assess and inspect data which has already been evaluated at the container by means of an evaluation unit, it is further particularly advantageous when corresponding data is transmitted by means of a transmitter in a wireless manner. A transmitter of this kind can use, for example, the normal mobile radio network in order to transmit data. In this way, it is possible for an authorized person to call up and inspect the corresponding data and be able to make individual decisions on the basis of said data.

In respect of the apparatus, the underlying problem is solved by means of a container having the features of claim 10. Advantageous refinements can be gathered from dependent claims 11 to 21.

The container according to the invention comprises at least one sensor device which has an adapter element. This adapter element is suitable for being connected, preferably in a releasable manner, to the gas connection of the tank, so that the sensor device is connected to the container. The adapter element comprises at least one gas connector and at least one medium channel, wherein the gas connector is suitable for receiving a protective gas line, so that protective gas can be conducted starting from the protective gas line, through the gas connector and through the medium channel of the adapter element, to the gas connection of the tank and finally into the interior of the tank. The sensor device further comprises at least one pressure sensor which interacts at least indirectly with the medium channel. Data relating to a pressure of the protective gas that is present in the medium channel can be detected by means of the at least one pressure sensor. As already outlined above, this pressure may be both a total pressure of the protective gas and partial pressures of said protective gas, for example a dynamic pressure and/or a static pressure.

The method according to the invention can be carried out in a particularly simple manner by means of the container according to the invention. In particular, data relating to a pressure within the medium channel can be gathered in a particularly simple manner by means of the at least one pressure sensor, from which data a conclusion can be drawn in the described manner about a removed quantity of filling material and therefore about a filling level of a respective container with filling material.

In a particularly advantageous refinement of the container, the medium channel of the adapter element has at least one constriction at which a cross section of the medium channel is reduced in relation to a cross section of the medium channel outside the constriction. The constriction is advantageously integrated into the medium channel in such a way that the cross section of the medium channel is widened on either side of the constriction. In other words, the medium channel is advantageously configured in such a way that gas flowing through the medium channel is accelerated in the region of the constriction and is then decelerated after leaving the constriction on account of the, in particular conical, widening of the medium channel. During the course of acceleration of the gas, the dynamic pressure of said gas is locally increased within the medium channel and the static pressure is accordingly reduced, provided that the total pressure of the gas, which is provided from a pressurized gas cylinder for example, remains constant.

Furthermore, it is particularly advantageous when the sensor device has at least one spur line which interacts in terms of flow with the medium channel of the adapter element. A longitudinal axis of the spur line is preferably oriented perpendicularly to a longitudinal axis of the medium channel, so that the spur line meets the medium channel in a perpendicular manner. An embodiment in which the spur line meets the medium channel in the region of an abovementioned constriction is particularly preferred. By means of a spur line of this kind, it is possible to arrange a pressure sensor at that end of said spur line which is averted from the medium channel, it being possible to detect changes in the pressure within the spur line by means of said pressure sensor. A refinement of this kind of the sensor device renders possible measurement of a change in the static pressure within the medium channel, which change is produced on account of a flow rate of the gas flowing through the medium channel. This is based on the consideration that the greater the flow rate of the gas in the region of the constriction, the higher the dynamic pressure and, conversely, analogously to this, the lower the static pressure of the gas in the medium channel, provided that a total pressure of the gas which is made available by means of a pressure source is constant.

As a result of the change in the static pressure in the medium channel, the pressure in the spur line, to which only the static pressure of the gas is applied on account of its preferred perpendicular orientation in relation to the medium channel, also changes, wherein this change can be determined by means of the pressure sensor. In this way, it is possible to initially determine, in principle, that protective gas is flowing through the medium channel and consequently filling material is obviously being removed from the tank of the container. Otherwise, the protective gas would not flow into the tank, but rather the static pressure would only increase where possible, depending on the pressure level of the source of the protective gas. As a result, the combination of the constriction, the spur line and the pressure sensor accordingly allows the flow conditions of a protective gas to be monitored by the sensor device.

By means of recording and then evaluating a profile of data which is determined by means of the pressure sensor, it is possible to ultimately make a statement about the time period over which protective gas has flowed through the sensor device into the interior of the tank. This can be used to draw the conclusion that filling material was removed from the tank over the same time period. With knowledge of this time period, it is consequently possible to make a statement about a remaining filling level of the tank after the time period for removal of filling material has ended. If it is determined, for example, by means of evaluation of a pressure profile of the protective gas that filling material was removed from the tank over a time period of 10 minutes, it is possible to determine, when the mass flow of removal of the filling material from the tank is known, the remaining filling level of said filling material in relation to the starting filling level at the beginning of removal. A pressure profile curve, which was detected by means of the pressure sensor and then recorded, can exhibit characteristic fluctuations, in particular at moments at which a pump for removing the filling material is activated and deactivated, it being possible to use the interpretation of said characteristic fluctuations in the manner described above to make a statement about a removal time and resulting from this a quantity of filling material removed. For example, the pressure profile curve can show a sudden drop at the moment at which the pump is activated, this being attributable to a flow of the protective gas within the medium channel being established. This begins because a released volume in the interior of the tank is “refilled” with protective gas which flows through the gas connection of the tank—and therefore beforehand through the medium channel of the sensor device—into the interior. As a result of the protective gas flowing through the medium channel, the static pressure drops in the region of the constriction on account of the increase in dynamic pressure, and this is registered as a pressure drop by means of the pressure sensor which is present in the spur line which is connected to the constriction. Conversely, the static pressure in the spur line rises again when removal of filling material from the tank is ended, so that the time at which removal is ended can be determined.

Monitoring the filling level of a tank is of particular interest during the course of removing the filling material in principle since the tank is usually completely filled during a filling process in any case, so that there is then always a full tank. However, during removal, it is very common for the filling material to be removed in stages, where possible over several days, so that it is of interest to precisely track the decrease in the filling level of the tank. Removal of the filling material from a respective tank can be highly individual depending on the use of the filling material and seldom follows the same pattern in practice.

### EXEMPLARY EMBODIMENT

The container according to the invention is explained in more detail below with reference to an exemplary embodiment which is illustrated in the figures, in which:

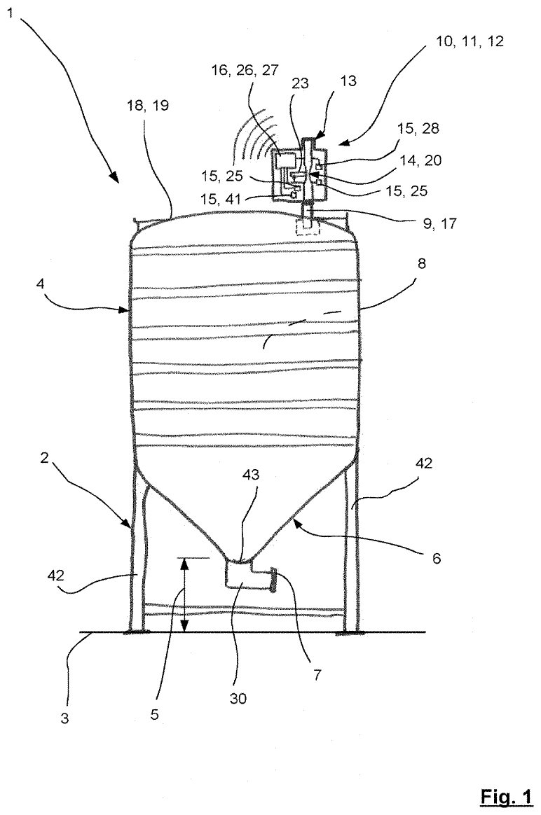

FIG. 1: shows a schematic side view of a container according to the invention,

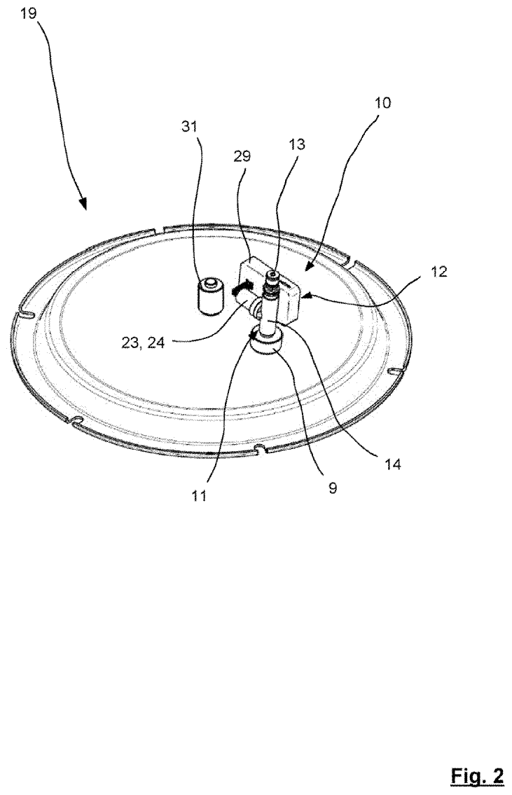

FIG. 2: shows a perspective view of a lid of the container according to FIG. 1,

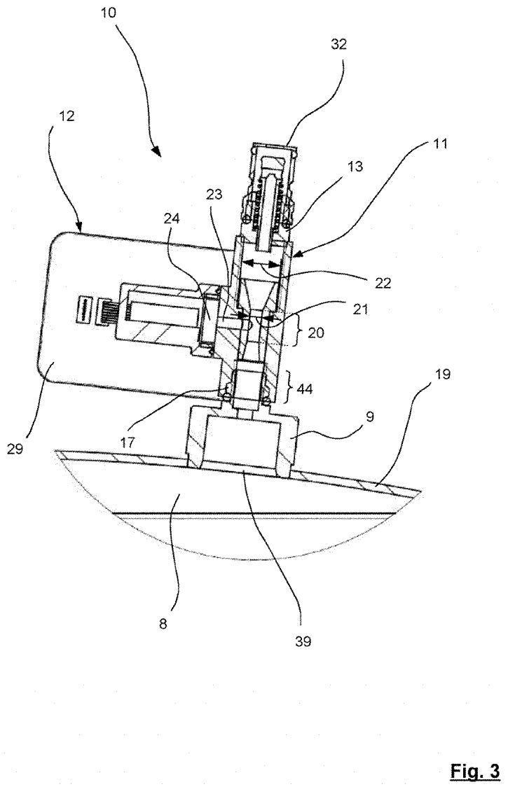

FIG. 3: shows a vertical cross section through a sensor device of the container according to FIG. 1,

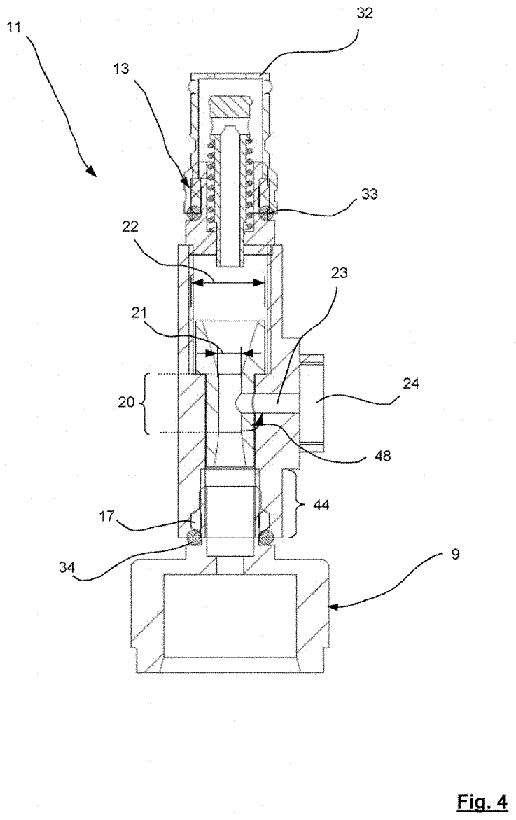

FIG. 4: shows a detail of the sensor device according to FIG. 3,

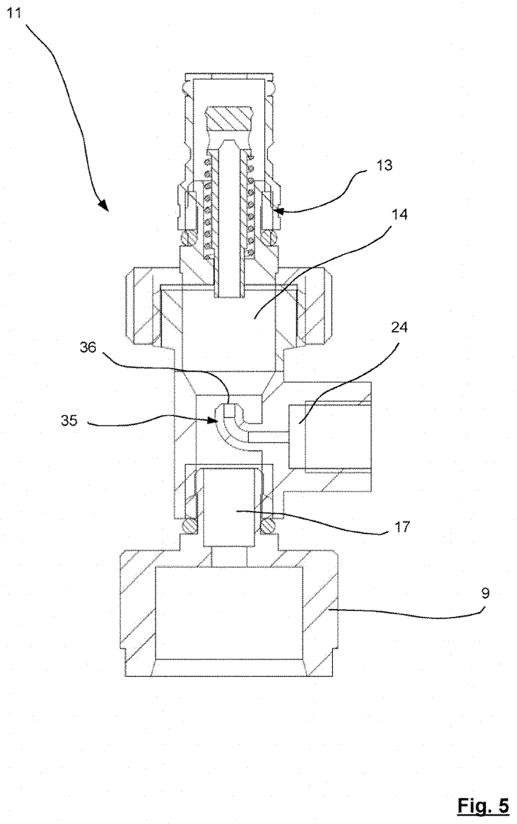

FIG. 5: shows a detail of an alternative sensor device,

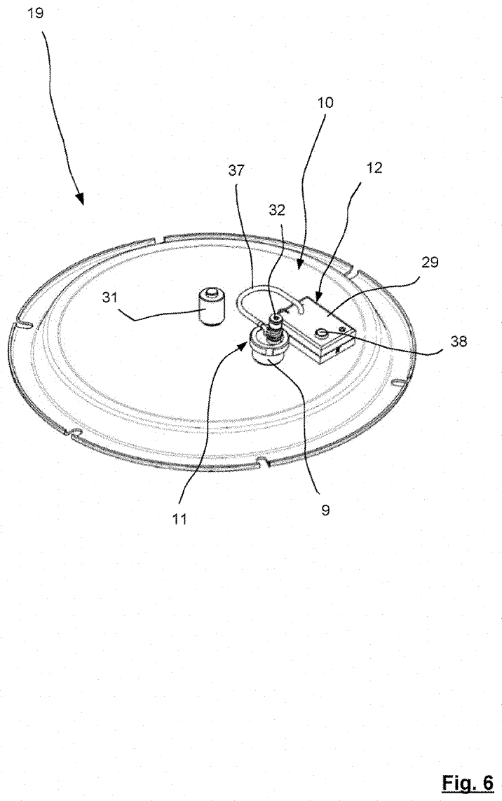

FIG. 6: shows a perspective view of a lid for a container according to FIG. 1, but with an alternative sensor device,

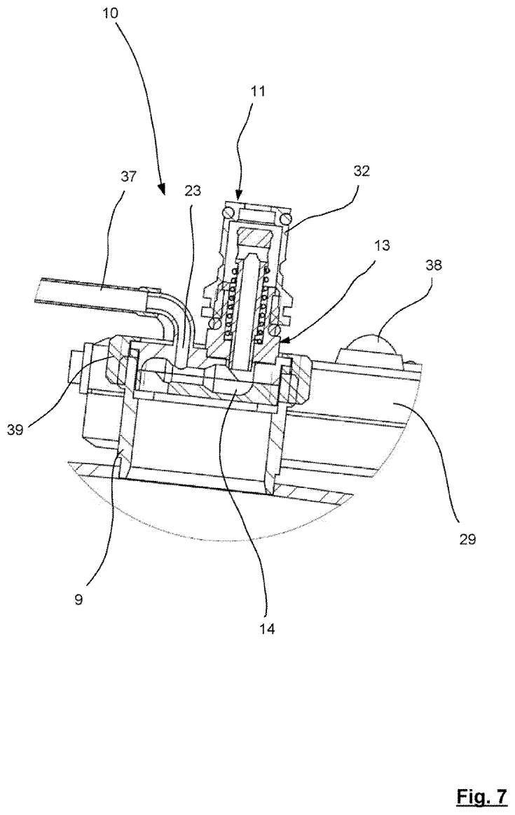

FIG. 7: shows a vertical cross section through the sensor device according to FIG. 6,

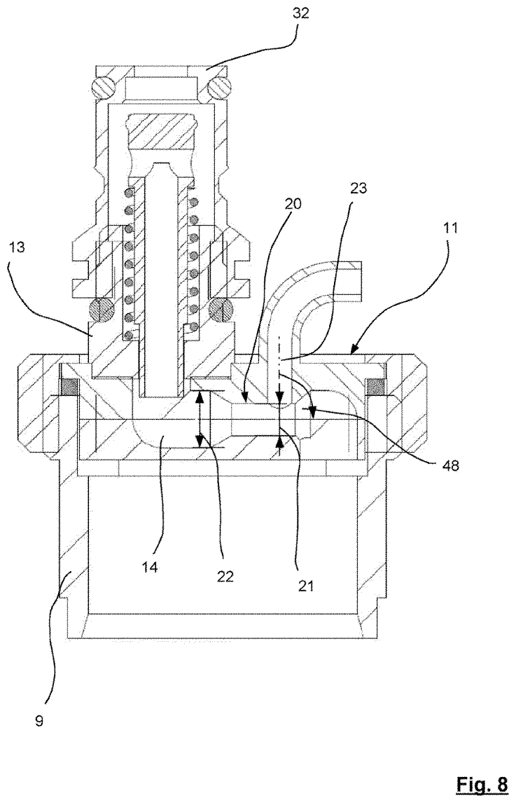

FIG. 8: shows a detail of the sensor device according to FIG. 7, and

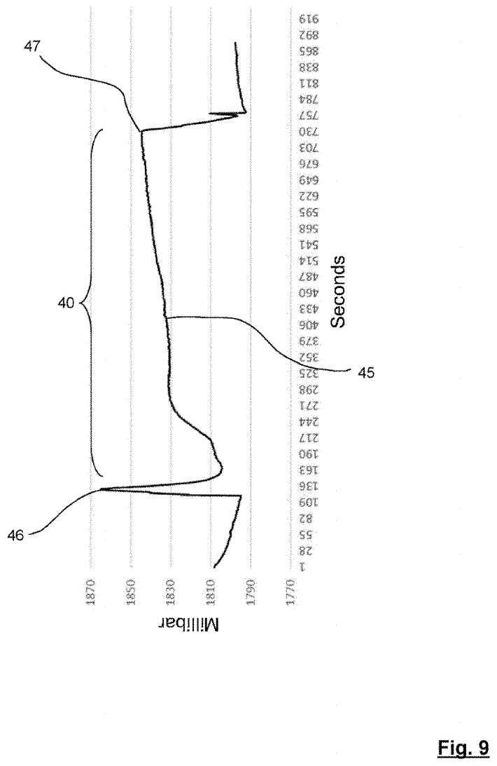

FIG. 9: shows a pressure profile curve during removal of filling material from a container according to the invention.

An exemplary embodiment, which is shown in FIGS. 1 to 9, comprises a container 1 according to the invention which comprises a tank 4 and a frame 2. The frame 2, in turn, comprises a plurality of legs 42 by means of which the container 1 stands on the ground 3. The tank 4 is mounted at a distance from the ground 3 by means of the frame 2 in such a way that a bottom side 6 of the tank 4 is accessible from below. In particular, a deepest point 43 of the tank 4 is located at a distance 5 from the ground 3. Said deepest point 43 interacts with an opening 7 through which an interior 8 of the tank 4 can be charged with filling material or said filling material can be removed from the interior 8. To this end, the tank 4 interacts with a connection pipe 30 which has an angle of 90°, so that a cross section of the opening 7 is oriented in a vertical manner. Here, the opening 7 interacts with a connection piece, so that a filling material hose can be coupled to the opening 7, it being possible for filling material to be removed from the tank 4 or, conversely, for filling material to be filled into the tank 4 by means of said filling material hose.

The container 1 according to the invention has a lid 19 on a top side 18, a gas connection 9 and a pressure-relief valve 31 being formed on said lid. This gas connection 9 serves to interact with a protective gas line, not illustrated in the figures. A protective gas line of this kind creates the possibility of feeding a protective gas, for example carbon dioxide, to the interior 8 of the tank 4. A protective gas of this kind is important in order to fill a free volume which is available in the tank 4 and is not filled with a respective filling material. In particular, there is often a requirement to prevent the filling material from coming into contact with oxygen, whereupon the filling material would oxidize. The protective gas prevents reactions of this kind and therefore contributes to a long shelf life of the filling material within the tank 4. The protective gas line is typically connected to a pressure source by means of which the respective protective gas is made available in a pressurized manner. This ensures that, during the course of removal of the filling material from the tank 4, protective gas accordingly directly subsequently flows into the released volume in the tank 4.

In the example shown, the gas connection 9 interacts with a gas connector 17 which is suitable here for interacting with a quick-action closure 32 of the protective gas line. In this way, it is particularly easily possible to connect the protective gas line to the gas connection 9 without tools and to establish a connection in terms of flow to the interior 8 of the tank 4. Conversely, it is likewise easily possible to remove the protective gas line from the gas connection 9 again.

According to the invention, the container 1 according to the invention comprises a sensor device 10 which comprises an adapter element 11 and a telemetry module 12. The adapter element 11 comprises a medium channel 14 and a gas connector 13. Furthermore, the adapter element 11 has a connection section 44 which is designed in a complementary manner to the gas connector 17 of the gas connection 9 of the tank 4. In this way, the sensor device 10 can be fixed to the gas connector 17, wherein the sensor device 10 can be plugged onto or is plugged onto the gas connector 17 in a certain manner. In this case, the gas connector 17 has a sealing ring 34 by means of which the adapter element 11 can be sealed off from the gas connection 9. The mechanism between the connection section 44 and the gas connector 17 is, in principle, identical to that by means of which a protective gas line can be connected to the gas connector 17. In this way, it is particularly easily possible to fix the sensor device 10 to the container 1, wherein the sensor device 10, by means of its adapter element 11, is detachably plugged onto the gas connector 17 only without tools and without destruction, and is latched in there.

At an end which is averted from the lid 19 of the container 1, the adapter element 11 has the gas connector 13 which interacts with a quick-action closure 32 in the example shown. The quick-action closure 32 is sealed off from the gas connector 13 of the adapter element 11 by means of a sealing ring 33. Here, the gas connector 13 is particularly advantageously designed to be compatible with the gas connector 17 of the tank 4. In particular, the gas nozzle 13 of the adapter element 11 reproduces the gas nozzle 17 of the gas connection 9 in an at least substantially, preferably completely, identical manner. This ensures that a respective protective gas line can be directly connected to the gas connector 13 of the adapter element 11, instead of to the gas connector 17 of the gas connection 9, without any need for adaptation or change. In this way, the container 1 according to the invention can continue to be used without any conversion, even though the actual gas connection 9 of the container 1 is now used for fixing the sensor device 10 to the container 1. The gas connector 13 of the adapter element 11 interacts in terms of flow with the medium channel 14 of said adapter element, so that, after a protective gas line is connected to the gas connector 13 (here using the quick-action closure 32), the respective protective gas can flow directly through the medium channel 14 to the gas connection 9 of the tank 4 and finally into the interior 8 of the tank 4.

In the example shown, the telemetry module 12 of the sensor device 10 comprises a plurality of sensors 15 and a transmitter 16. In particular, the telemetry module 12 has a geoposition sensor 41, an acceleration sensor 25, a temperature sensor 28, a data logger 26 and an evaluation unit 27. These components of the telemetry module 12 are accommodated together in a housing 29 which protects said components against external influences, in particular moisture and dirt. The sensors 15 are suitable for detecting data relating to at least one state parameter of the container 1 and/or a state parameter of the filling material which is stored in the container 1. Said data can be transmitted—possibly after being buffer-stored in the data logger 26 and possibly after being processed by means of the evaluation unit 27—by means of the transmitter 16, so that said data can be called up remotely in a wireless manner. For example, it is conceivable to detect an absolute position of the container 1 by means of the geoposition sensor 41 and to transmit said absolute position by means of the transmitter 16. In this way, it is possible, for example, for a customer who has purchased a respective filling material to monitor a location of the container 1 and in this way estimate when the container 1 can be expected at his premises. In the same way, it is conceivable to permanently monitor a temperature of the filling material, as a result of which quality assurance is simplified. The detected data can be stored by means of the data logger 26, so that not only can respectively current data records additionally be called up, but rather a history can also be evaluated in particular. Furthermore, acceleration states of the container 1 can be detected by means of the at least one acceleration sensor 25, wherein, for example, it can be inferred that there has been an accident in the case of sharp fluctuations.

In the exemplary embodiment shown according to FIG. 3, the medium channel 14 of the adapter element 11 comprises a constriction 20 in the region of which a cross section 21 of the medium channel 14 is reduced in relation to a cross section 22 outside the constriction 20. In particular, the constriction 20 is designed in such a way that the medium channel 14 widens on either side of the constriction 20. In this way, the medium channel 14 is designed in the form of a Venturi nozzle in the region of the constriction 20. The reduction in the cross section of the medium channel 14 leads to the protective gas flowing through the medium channel 14 being accelerated in the region of the constriction 20. Accordingly, a flow rate of the protective gas 20 in the region of the constriction 20 is greater than in a region outside the constriction 20. This leads to a dynamic pressure of the protective gas increasing in the region of the constriction 20, as a result of which a static pressure, which presses hydrostatically on a wall of the medium channel 14, conversely decreases.

Furthermore, the medium channel 14 interacts with a spur line 23, the longitudinal axis of which is oriented perpendicularly to a longitudinal axis of the medium channel 14. In other words, the spur line 23 meets the medium channel 14 in the region of the constriction 20 at an angle 48, here a 90° angle. At an end which is averted from the medium channel 14, the spur line 23 interacts with a pressure sensor 24. Said pressure sensor is suitable for detecting data relating to a static pressure within the spur line 23. According to the above explanation, said static pressure changes as soon as protective gas flows through the medium channel 14. A flow of this kind can accordingly be determined by means of a change in the pressure within the spur line 23, wherein said change is detected by means of the pressure sensor 24. In this way, it is possible to determine by means of the sensor device 10 immediately when protective gas flows through the adapter element 11. The latter, in turn, usually happens only when filling material is removed from the interior 8 of the tank 4, wherein a released volume within the tank 4 is filled with additional protective gas as a result. Accordingly, it is conceivable, for example, for the beginning of removal of filling material from the tank 4 to be identified in the form of a drop in pressure in a pressure profile curve which is created using data which is gathered by means of the pressure sensor 24.

This phenomenon can be identified, for example, on the basis of a pressure profile curve 45 which is illustrated in FIG. 9. Here, a peak 46 can be identified in particular, which peak initially identifies connection of a protective gas line to the container 1, as a result of which the static pressure at the pressure sensor 24 sharply increases. This is due to the protective gas line being connected to a pressure source, the pressure of which pressure source exceeds an internal pressure of the tank 4. At the beginning of removal of the filling material from the tank 4, a directed flow of the protective gas through the medium 14 then takes place, whereupon the static pressure at the pressure sensor 24 drops suddenly in accordance with the above explanation. The sharp drop in the pressure profile curve 45 in the region of the peak 46 can therefore indicate the beginning of removal of filling material from the tank 4. Furthermore, the pressure profile curve 45 can identify a further high point 47 from which the pressure profile curve 45 drops sharply. This point can be interpreted as the time at which the tank 4 is completely emptied, that is to say all of the filling material has been removed from the tank 4. A pump by means of which the filling material is removed by suction from the tank directly draws the protective gas at this time, so that the static pressure within the container 1 and analogously within the medium channel 14 and the spur line 23 decreases suddenly. Accordingly, said high point 47 can be interpreted as the time at which the tank 4 is completely emptied.

Continuous detection of the pressure by means of the pressure sensor 24 allows analysis of the filling level of the tank 4 with filling material by way of at least one time period 40 within which removal of filling material from the container 1 takes place being able to be detected. In the example shown in FIG. 9, removal takes place in such a way that the tank 4 of the container 1 is finally completely emptied. As an alternative, it is likewise conceivable for removal of the filling material to be at least temporarily ended before the tank 4 is completely emptied. End of removal would be identifiable in the pressure profile curve 45 on the basis of a sudden increase in the static pressure since, without removal of further filling material from the tank 4, a flow of protective gas through the medium channel 14 would become established and consequently the dynamic pressure decreases, while the static pressure increases. On the basis of the pressure profile curve 45, the time period over which filling material has been removed from the tank 4 can then finally be determined. Conversely, a statement can be made as a result about the filling level of filling material still present within the tank 4. Consequently, it is possible to monitor a filling level of the tank 4 of the container 1 by means of monitoring the pressure by means of a pressure sensor 24 of the sensor device 10.

In an alternative refinement of the adapter element 11, a change in the pressure within the medium channel 14 is not detected in accordance with the Venturi principle according to the above explanation, but rather by means of a so-called pitot tube 35. A corresponding refinement can be gathered with reference to FIG. 5. Said pitot tube 35 has an opening cross section 36 which is oriented perpendicularly to a flow direction of the protective gas and through which flowing protective gas can enter the pitot tube 35 and can finally be conducted to a pressure sensor 24. By means of an arrangement of this kind, the dynamic pressure in the protective gas within the medium channel 14 or a change in said dynamic pressure can be detected, so that it is also possible to determine with an arrangement of this kind immediately when a flow of protective gas through the medium channel 14 starts. According to the above explanation, the occurrence of a flow of this kind can be associated with removal of filling material from the tank 4, so that the beginning and the end of removal of filling material from the container 1 can be detected on the basis of data detected by the pressure sensor 24, wherein finally a conclusion can be drawn about the filling level of the filling material within the tank 4 by means of determining a time period over which removal has taken place.

An alternative embodiment of a sensor device 10, which is illustrated in FIGS. 6 to 8, comprises an adapter element 11 which is designed to be significantly smaller than the sensor devices 10 according to FIGS. 3 to 5. Said sensor device 10 is connected to the gas connection 9 of the tank 4 by means of a union nut 39. In the example shown, the gas connection 9 as such does not have a dedicated gas connector 17, so that connection of a protective gas line to the tank 4 is possible only via the gas connector 13 of the adapter element 11. The associated container 1 is accordingly designed in such a way that it depends on the arrangement of the sensor device 10 on the gas connection 9 in order to be used as intended. In contrast to the sensor devices 10 described above, in the alternative variant the medium channel 14 is oriented at least substantially horizontally, as a result of which the required installation space volume of the adapter element 11 is considerably reduced. Comparably to the construction described above, the sensor device 10 according to FIGS. 6 to 8 also has, in its medium channel 14, a constriction 20 in which the cross section 21 of the medium channel 14 is reduced in relation to the cross section 22 of said medium channel outside the constriction 20. The sensor device 10 also has a spur line 23 which is connected to the medium channel 14 so as to form an angle 48 in the region of the constriction 20, wherein the angle 48 is formed by a right angle here. In this way, analogously to the above explanation, a change in the static pressure within the medium channel 14 can be detected, wherein the spur line 23 is designed in the form of a bent pipe here, a flexible connecting line 37 being connected in a leaktight manner at the end of said pipe. Said connecting line 37 interacts with a pressure sensor 24 at an end which is averted from the adapter element 11, which pressure sensor is accommodated in the associated telemetry module 12 here.

Here, the latter has a cuboidal housing 29 which is connected in a force-transmitting manner to the lid 19 of the container 1 in principle independently of the adapter element 11, in particular by means of a screw connection. Here, the telemetry module 12 has an LED 38 by means of which a state of operation of the telemetry module 12 or of the sensors 15 located in said telemetry module can be optically indicated.

### LIST OF REFERENCE SIGNS

1 Container
2 Frame
3 Ground
4 Tank
5 Distance
6 Bottom side
7 Opening
8 Interior
9 Gas connection
10 Sensor device
11 Adapter element
12 Telemetry module
13 Gas connector
14 Medium channel
15 Sensor
16 Transmitter
17 Gas connector
18 Top side
19 Lid
20 Constriction
21 Cross section
22 Cross section
23 Spur line
24 Pressure sensor
25 Acceleration sensor
26 Data logger
27 Evaluation unit
28 Temperature sensor
29 Housing
30 Connection pipe
31 Pressure-relief valve
32 Quick-action closure
33 Sealing ring
34 Sealing ring
35 Pitot tube
36 Opening cross section
37 Connecting line
38 LED
39 Opening
40 Time period
41 Geoposition sensor
42 Leg
43 Deepest point
44 Connection section
45 Pressure profile curve
46 Peak
47 High point
48 Angle

1.-21. (canceled)

22. A method for operating a container for flowable filling material, the container comprising a tank and a frame, the tank being supported by the frame at a distance from the ground so that a bottom side of the tank is accessible, the bottom side of the tank having opening through which the filling material can be conducted into an interior of the tank for filling the tank and through which the filling material can be removed from the interior, and the tank having a gas connection connectable with a protective gas line, wherein the method comprises the steps of:
connecting a protective gas line to the gas connection and applying pressure in said protective gas line before removal of flowable filling material from the tank, so that a protective gas can flow into an interior of the tank through a medium channel when the flowable filling material is removed from the tank;
connecting a removal apparatus to the opening of the tank, and removing the flowable filling material from the interior of the tank through the opening by the removal apparatus; and
detecting, by a pressure sensor, data relating to a pressure of the protective gas in the medium channel during a time period of the removing the flowable filling material from the interior of the tank.

23. The method as claimed in claim 22, wherein the data detected by the pressure sensor relates to one of the group consisting of a static pressure and a dynamic pressure of the protective gas within the medium channel.

24. The method as claimed in claim 22, wherein a flow of the protective gas in the medium channel is accelerated in at least one region so that a dynamic pressure of the protective gas increases.

25. The method as claimed in claim 24, wherein the flow of the protective gas is accelerated by a constriction arranged in the medium channel.

26. The method as claimed in claim 22, further comprising the step of determining times at which removal of the filling material begins and ends based on the detected data, wherein a difference between the times is the time period of the removing of the flowable filling material.

27. The method as claimed in claim 26, further comprising the step of determining a quantity of the flowable filling material that is removed from the tank based on the time period of removal.

28. The method as claimed in claim 22, further comprising the step of storing the data detected by the pressure sensor at least temporarily by a data logger.

29. The method as claimed in claim 22, further comprising the step of processing the data detected by the pressure sensor by an evaluation unit.

30. The method as claimed in claim 22, further comprising the step of transmitting the data by a wireless transmitter.

31. A container for transporting a flowable filling material, comprising:
a frame configured to place the container on the ground;
a tank for storing the filling material, the tank being supported by the frame at a distance from the ground so that a bottom side of the tank is accessible, the bottom side of the tank having opening through which the filling material is conducted into an interior of the tank for filling the tank and through which the filling material is removed from the interior, and the tank having a gas connection connectable with a protective gas line;
a sensor device including an adapter element, which includes a gas connector and a medium channel, the sensor device being connectable to the gas connection of the tank by the adapter element, wherein the gas connector of the adapter element is connectable to a protective gas line when the sensor device is connected to the gas connection of the tank so that a protective gas is conductible through the gas connector and the medium channel of the adapter element and into the interior of the tank; and
a pressure sensor interacting with the medium channel and detecting data relating to a pressure of protective gas prevailing in the medium channel.

32. The container as claimed in claim 31, wherein the sensor device releasably connectable to the gas connection of the tank by the adapter element.

33. The container as claimed in claim 31, wherein the medium channel has a constriction at which a cross section of the medium channel is reduced in relation to a cross section of the medium channel outside the constriction.

34. The container as claimed in claim 33, wherein the medium channel is widened in relation to the cross section of the constriction on either side of the constriction.

35. The container as claimed in claim 31, wherein the sensor device has a spur line that interacts in terms of flow with the medium channel of the adapter element.

36. The container as claimed in claim 33, wherein the sensor device has a spur line connected to the medium channel in the region of the constriction.

37. The container as claimed in claim 35, wherein the pressure sensor is arranged at an end of the spur line remote from the medium channel, so that pressure fluctuations within the spur line that occur as a result of protective gas flowing through the medium channel are detectable by the pressure sensor.

38. The container as claimed in claim 31, further comprising a pitot tube with an opening cross section arranged within the medium channel, the opening cross section being oriented in relation to the flow direction of the protective gas in the medium channel in such a way that a portion of the protective gas enters the pitot tube, and the pitot tube connecting the opening cross section in a fluid-conducting manner to the pressure sensor.

39. The container as claimed in claim 38, wherein the opening cross section is oriented perpendicularly to a flow direction of the protective gas in the medium channel.

40. The container as claimed in claim 31, further comprising a data logger that at least temporarily stores data detected by the pressure sensor.

41. The container as claimed in claim 31, further comprising an evaluation unit that processes the data detected by the pressure sensor.

42. The container as claimed in claim 31, further comprising a transmitter that wirelessly transmits the data.
